(19) United States
(12) Patent Application Publication
(10) Pub. No.: US 2018/0245661 A1
(43) Pub. Date: Aug. 30, 2018

(54) POWERTRAIN MOUNT SYSTEM

(71) Applicant: Ford Global Technologies, LLC, Dearborn, MI (US)

(72) Inventors: Matt Sykes, Wickford (GB); Tom Thompson, Brentwood (GB)

(21) Appl. No.: 15/905,527

(22) Filed: Feb. 26, 2018

(30) Foreign Application Priority Data
Feb. 27, 2017 (GB) 1703103.0

(51) Int. Cl. F16F 15/00; B60K 5/12; F16F 15/03

(52) U.S. Cl. CPC F16F 15/005; F16F 2222/06; F16F 15/03; B60K 5/1283

(57) ABSTRACT

A powertrain mount system for a vehicle powertrain, the system comprising: an active magnetic bearing configured to support at least a portion of the powertrain relative to a body portion of a vehicle; and a controller configured to determine an operational state of at least one of the powertrain and the vehicle and adjust the operation of the active magnetic bearing depending on the operational state of at least one of the powertrain and the vehicle.

### CROSS REFERENCE TO RELATED APPLICATION

This application claims priority to Great Britain Patent Application No. 1703103.0, filed Feb. 27, 2017. The entire contents of the above-referenced application are hereby incorporated by reference in its entirety for all purposes.

### FIELD

This disclosure relates to a powertrain mount system for a vehicle, and in particular, but not exclusively, relates to an electromagnetic suspension system that is adjustable in response to vehicle dynamics.

### BACKGROUND AND SUMMARY

It is common for a vehicle to have a powertrain mount system that is configured to support a powertrain of the vehicle relative to the vehicle body. However, the design of the powertrain mount system is complex as it has many requirements to fulfil. For example, the powertrain mount system is required to locate and constrain the powertrain, isolate vibration from the powertrain, reduce road induced loads, meet durability requirements and be lightweight.

It is common for a vehicle to have a plurality of brackets that are configured to support the powertrain relative to the vehicle body. In many applications, the brackets are fitted with rubber mounts that are designed to reduce the transmission of vibration from the powertrain to the vehicle body, and vice versa.

To maximize vibration absorption at idle and during wide open throttle events, it is desirable for the powertrain mount system to have a low stiffness/high displacement characteristic. However to minimize transient behavior and wear to components during dynamic maneuvers, such as cornering and gear changes, a high stiffness/short displacement characteristic is desired. As such, there is a trade-off, which leads to sub-optimal system behavior and a system that cannot meet all requirements.

According to an aspect of the present disclosure there is provided a powertrain mount system for a powertrain, e.g. a powertrain of a vehicle. The system comprises: an active magnetic bearing configured to support at least a portion of the powertrain relative to a body portion of the vehicle; and a controller configured to determine an operational state of at least one of the powertrain and the vehicle and adjust the operation of the active magnetic bearing depending on the operational state of at least one of the powertrain and the vehicle.

The powertrain mount system may comprise one or more mounting brackets configured to be secured to a portion of the powertrain. The powertrain mount system may comprise one or more mounting brackets configured to be secured to a portion of a vehicle. The mounting bracket on the powertrain and the mounting bracket on the vehicle may cooperate to restrict the movement of the powertrain relative to the vehicle. There may be an operational clearance between the mounting bracket on the powertrain and the mounting bracket on the vehicle when the powertrain is installed to the vehicle. The active magnetic bearing may be configured to maintain the operational clearance between the mounting bracket on the powertrain and the mounting bracket on the vehicle.

The powertrain mount system may comprise one or more spacers, for example stops/bumpers, configured to prevent the mounting brackets on the powertrain and the mounting brackets on the vehicle from contacting each other. The spacers may be provided in the operation clearance in between the mounting brackets on the powertrain and the mounting brackets on the vehicle. The spacers may comprise a resilient material, e.g. rubber.

The active magnetic bearing may be configured to at least partially support the powertrain in one or more degrees of freedom.

The powertrain mount system may comprise a passive magnetic bearing. The passive magnetic bearing may be configured to at least partially support the powertrain in one or more degrees of freedom.

The powertrain mount system may comprise one or more sensors configured to determine the loading, e.g. dynamic loading, of the powertrain relative to the vehicle. For example, the powertrain mount system may comprise one or more load sensors and/or one or more accelerometers configured to determine the loading, e.g. dynamic loading, of the powertrain relative to the vehicle. The controller may be configured to adjust the stiffness of the active magnetic bearing in response to loading, e.g. dynamic loading, of the powertrain. For example, the controller may be configured to determine the vertical and/or horizontal movement and/or acceleration of one or more components of the powertrain as the vehicle operates.

The controller may be configured to maintain the stiffness of the active magnetic bearing under steady state loading of the powertrain. The controller may be configured to increase the stiffness of the active magnetic bearing in response to an increase in the power output of the powertrain. The controller may be configured to decrease the stiffness of the active magnetic bearing in response to a decrease in the power output of the powertrain. The controller may be configured to increase the stiffness of the active magnetic bearing in response to the vehicle performing a maneuver, such as cornering or changing lanes.

The controller may be configured to adjust the stiffness of the active magnetic bearing in response to an operational frequency of the powertrain. For example, the controller may be configured to decrease the stiffness of the active magnetic bearing when the operational frequency of the powertrain is in the range of approximately 10 to 25 Hz.

According to another aspect of the present disclosure there is provided a powertrain mount comprising a first bracket, for example that is attachable to a body portion of a vehicle, and a second bracket, for example that is attachable to a portion of the powertrain, and an electromagnet configured to support the first and second brackets relative to each other.

The powertrain mount may comprise one or more sensors, for example a position sensor, configured to measure an operational clearance between the first and second brackets when the electromagnet is energized. The sensor may be integral with at least one of the first bracket and the second bracket. For example, the sensor may be integrated into the body of the first bracket or the second bracket during manufacture of the first bracket or the second bracket. The sensor may be integral with the electromagnet. For example, the sensor may be integrated into the body of the electromagnet during manufacture of the electromagnet.

A vehicle may be provided comprising one or more of the above mentioned powertrain mount systems and/or powertrain mounts.

According to another aspect of the present disclosure there is provided a method of controlling a powertrain mount system for a vehicle, the electromagnetic suspension system comprising an active magnetic bearing configured to support at least a portion of the powertrain relative to the vehicle, and a controller configured to determine an operational state of at least one of the powertrain and the vehicle, the method comprising: determining the operational state of at least one of the powertrain and the vehicle; and adjusting the operation of the active magnetic bearing depending on the operational state of at least one of the powertrain and the vehicle.

In the context of the present disclosure the term “powertrain” is understood to be the components of a vehicle that generate power and deliver it to a final drive component, for example a wheel, of a vehicle. The powertrain of a vehicle may include at least one of an engine, for example an internal combustion engine, a motor, for example an electric motor, a transmission, a drive shaft, and a differential. Further, where referred to in the present disclosure, the term “powertrain” is understood to exclude a final drive component, such as a wheel. In this manner, the powertrain mount system according to the present disclosure is differentiated from an electromagnetic suspension system of a vehicle, which is configured to support the vehicle body relative to a wheel of the vehicle. As such, the powertrain mount system according to the present disclosure is configured to support at least one of an engine, a motor, a transmission, a drive shaft, and a differential relative to the vehicle body.

The disclosure also provides software, such as a computer program or a computer program product for carrying out any of the methods described herein, and a computer readable medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 shows an arrangement for an electromagnetic powertrain mount;

FIG. 2 shows a powertrain mount system for a vehicle; and

FIG. 3 shows a flowchart depicting a method of controlling a powertrain mount system.

### DETAILED DESCRIPTION

It is common for a powertrain mount system for a vehicle to comprise a physical connection between a vehicle powertrain and a body portion of the vehicle. To maximize vibration absorption, for example at engine idle speeds and/or during wide open throttle events, it is desirable for the powertrain mount system to have a low stiffness/high displacement characteristic. However, to optimize transient response and reduce wear to components during dynamic loading, a high stiffness/short displacement characteristic is desired. In some cases, a powertrain mount system may comprise a bracket that has a resilient member, such as a rubber block, configured to support the powertrain on the vehicle body. However, the use of such a powertrain mount system results in a compromise in the performance characteristics of the powertrain mount system, for example a compromise between vibration transmissivity and the stiffness of the powertrain mount system.

The present disclosure provides a powertrain mount system having an active magnetic bearing configured to support at least a portion of a powertrain relative to a vehicle body, which is beneficial as it removes the physical connection between the powertrain and the vehicle body, allowing the powertrain mount system to reduce vibration transmissivity while maintaining a high stiffness characteristic.

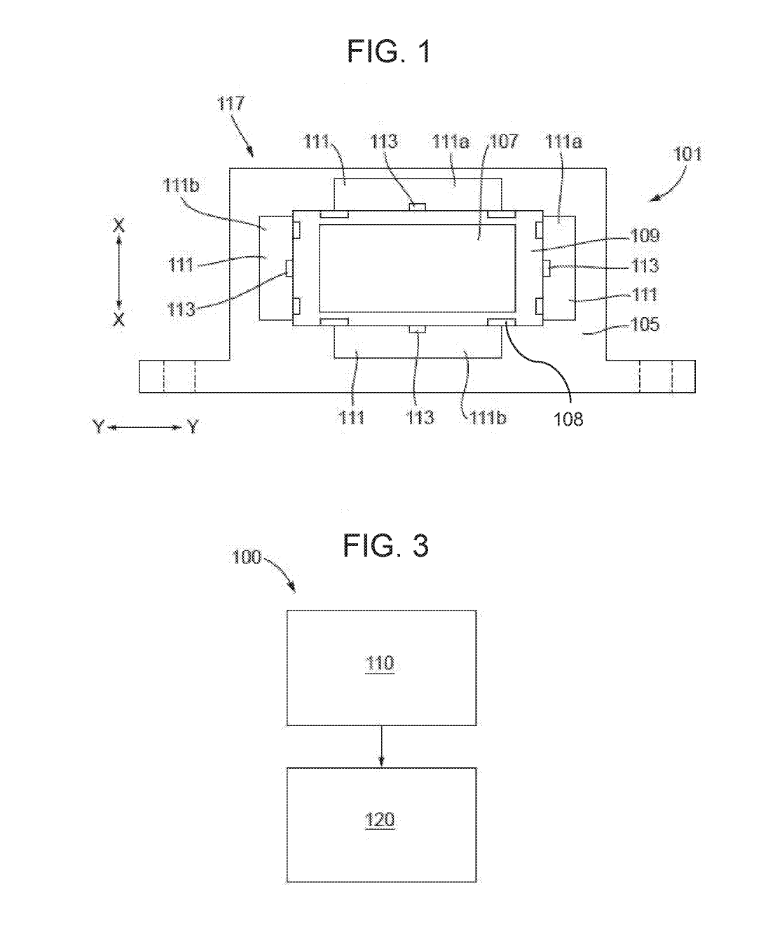

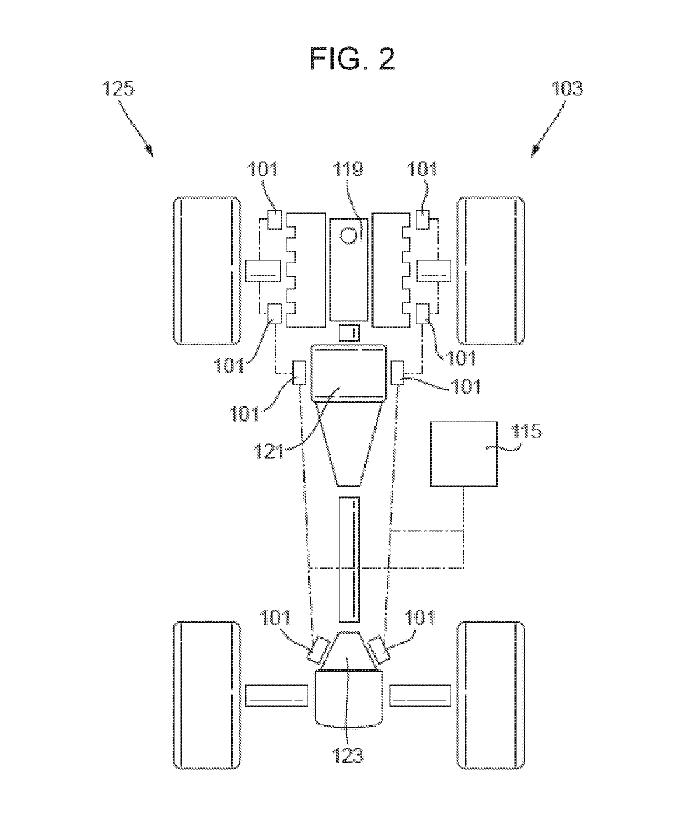

FIGS. 1 and 2 show a powertrain mount 101 and a powertrain mount system 103 respectively. In the arrangement shown in FIG. 1, the powertrain mount 101 is an engine mount comprising a first bracket 105, which may be attached to a body portion of the vehicle inside an engine bay of the vehicle, and a second bracket 107, which may be attached to a portion of the engine. However, the first and second brackets 105, 107 may be configured to attach to any appropriate portion of the vehicle body and the powertrain respectively. For example, the first bracket 105 may be configured to attach to a rear subframe of the vehicle, and the second bracket 107 may be configured to attach to a differential of the powertrain, the first and second brackets 105, 107 cooperating to limit the movement of the differential relative to the rear subframe.

In the arrangement shown in FIG. 1, the first bracket 105 comprises an opening 109 configured to receive the second bracket 107 so that there is an operational clearance between the first bracket 105 and the second bracket 107 when the second bracket 107 is received in the opening 109. The first bracket 105, the second bracket 107 and the opening 109 may each have any appropriate shape/form as required by the function the powertrain mount 101. For example, the operational clearance may extend completely around the second bracket 107, as shown in FIG. 1, or may extend only partially around the second bracket 107, in one or more other arrangements.

The powertrain mount 101 comprises at least one electromagnet 111 configured to interact with the second bracket 107. For example, the second bracket 107 may comprise a portion of ferrous material that is magnetically attracted towards the electromagnet 111 when it is energized. The force of magnetic attraction is dependent upon the magnetic flux density generated by the electromagnet 111. As such, where a larger current is supplied to the electromagnet 111, the force of magnetic attraction is greater, and where a smaller current is supplied to the electromagnet 111, the force of magnetic attraction is less.

As shown in FIG. 1, the electromagnets 111 may be provided in pairs. For example, each pair of electromagnets 111 may comprise a first electromagnet 111a arranged opposite a second electromagnet 111b. Since each of the first electromagnet 111a and the second electromagnet 111b act to attract the second bracket 107 in opposite directions, the first electromagnet 111a and the second electromagnet 111b may be controlled to balance the attractive forces so as to maintain the second bracket 107 substantially in between the first electromagnet 111a and the second electromagnet 111b.

In the arrangement shown in FIG. 1, the first bracket 105 comprises a plurality of electromagnets 111 that are disposed circumferentially around the opening 109 of the first bracket 105. For example, the first bracket 105 is provided with two pairs of opposing electromagnets 111a, 111b, each pair being configured to support the second bracket 107 relative to the first bracket 105 along a single axis. The first pair of electromagnets 111a, 111b is arranged to support the second bracket 107 along an axis indicated by the X arrow on FIG. 1, and the second pair of electromagnets 111a, 111b is arranged to support the second bracket 107 along an axis indicated by the Y arrow on FIG. 1. In this manner, the interaction between the electromagnet 111 of the first bracket 105 and the ferrous material of the second bracket 107 acts to support the first and second brackets 105, 107 relative to each other, so as to maintain the operational clearance between the first and second brackets 105, 107 when the electromagnets 111 are energized.

In one or more other arrangements, the electromagnets 111 may be arranged to support the second bracket 107 relative to the first bracket 105 in any appropriate number of degrees of freedom. Additionally or alternatively, the second bracket 107 may comprise one or more permanent magnets (not shown) configured to interact with the electromagnets 111 to at least partially support the second bracket 107 relative to the first bracket 105. The permanent magnets may be arranged so as to provide a magnetically attractive and/or repulsive force between the first and second brackets 105, 107, depending on the energized state of the electromagnets 111.

In one arrangement, the powertrain mount 101 may comprise a permanent magnetic bearing that may be used in combination with the above-described electromagnetic bearing. For example, the powertrain mount 101 may comprise a permanent magnetic bearing configured to at least partially support the mass of the powertrain under static conditions. In other words, the permanent magnetic bearing configured to maintain a vertical operational clearance between the first and second brackets 105, 107.

It is understood, however, that the particular arrangement of the active magnetic bearing is not limited to that shown in the appended figures. For example, in some arrangements, one or more electromagnets 111 may be provided on the second bracket 107, and/or one or more permanent magnets may be provided on the first bracket 105. The magnetic bearing may have any appropriate configuration that provides at least partial support of the powertrain relative to the vehicle body.

The powertrain mount system 103 further comprises one or more position sensors 113, for example one or more proximity sensors, configured to measure the spacing between the first and second brackets 105, 107. In the arrangement shown in FIG. 1, each of the position sensors 113 are provided proximate to respective electromagnets 111 in the first bracket 105. However, the position sensors 113 may be provided in any appropriate location so as to measure size of the operational clearance between the first and second brackets 105, 107. For example, the position sensors 113 may be provided on the second bracket 107. The position sensors 113 may be operatively connected to the electromagnets 111, for example via a controller 115, so as to form an active magnetic bearing 117. For example, the controller 115 may be configured to determine the position of the second bracket 107 within the opening 109 using one or more measurements taken from the position sensors 113. The controller 115 may be configured to adjust the operational state of the electromagnets 111 to control the flux density generated by the electromagnets 111. In this manner, the controller 115 is configured to adjust the attractive and/or repulsive forces of the powertrain mount 101 based on the operational clearance surrounding the second bracket 107.

In the arrangement shown in FIG. 1, the powertrain mount system 103 comprises one or more spacers 108, for example stops/bumpers, configured to prevent the first and second brackets 105, 107 from contacting each other. The spacers 108 may be advantageous to avoid contact between the first and second brackets 105, 107 under shock loading and/or when the electromagnets are powered down, e.g. when the vehicle is turned off.

FIG. 2 shows one arrangement of the powertrain mount system 103 according to the present disclosure. In the arrangement shown in FIG. 2, the powertrain mount system 103 is configured to support an engine 119, a transmission 121 and a rear differential 123 of a vehicle 125 relative to a body of the vehicle 125. For clarity, the body of the vehicle 125 is not shown in FIG. 2, and it is understood that the vehicle may be any type of vehicle, such a car, a van, a truck, a marine vessel or an aircraft.

In the arrangement shown in FIG. 2, the powertrain mount system 103 comprises eight powertrain mounts 101 similar to the above described powertrain mount 101. The engine 119 is supported by four powertrain mounts 101, and the transmission 121 and the differential are each supported by two powertrain mounts 101. Each of the powertrain mounts 101 are operatively connected to the controller 115. The controller 115 may be an electronic control unit (ECU) of the vehicle 125, or may be a separate controller 115 configured to interface with the ECU of the vehicle. The ECU may comprise at least one of an electronic/engine control module, a powertrain control module (PCM), a transmission control module (TCM), a brake control module (BCM), a central control module (CCM), a central timing module (CTM), a body control module (BCM), a suspension control module (SCM), and any other appropriate control module. As such, the controller 115 may be configured to determine the operational state of the powertrain and/or the operational state of the vehicle itself. For example, the controller 115 may be configured to determine the power output from the engine 119, a selected gear of the transmission 121, and/or the operational state of the differential 123. Additionally or alternatively, the controller 115 may be configured to determine the general dynamics of the vehicle 125, for example based on the operational state of at least one of a suspension system, a steering system and the roll/pitch/yaw of the vehicle 125, amongst other parameters. In this manner, the controller 115 is able to determine an operational state of at least one of the powertrain and the vehicle, and adjust the operation of at least one of the active magnetic bearings 117 of the powertrain mount system 103 depending an operational parameter of at least one of the powertrain and the vehicle.

FIG. 3 shows an example control method 100 of the powertrain mount system 103. The method 100 comprises a step 110 of determining the operational state of at least one of the powertrain and the vehicle 125 and a step 120 of adjusting the operation of at least one active magnetic bearing 117 of the powertrain mount system 103 depending on the operational state of at least one of the powertrain and the vehicle 125.

In one arrangement, depending on the operation of the powertrain, the controller 115 may be configured to adjust the stiffness of the active magnetic bearing in response to dynamic loading of the powertrain. For example, the controller 115 may be configured to determine the vertical and/or horizontal movement and/or acceleration of one or more components of the powertrain as the vehicle operates, and adjust the stiffness of at least one of the active magnetic bearings 117 in response to the operation of the powertrain. The powertrain mount system 103 according to the present disclosure is beneficial, therefore, as it is able to minimize the displacement of the powertrain under shock loading. For example, where the vehicle 125 accelerates quickly and/or performs a maneuver, such as cornering and/or lane changing, the controller 115 is operable to increase the stiffness of one or more of the active magnetic bearings 117 in response to an increase in the power output of the powertrain and/or dynamic characteristics of the vehicle. Such an increase in stiffness acts to increase the efficiency of the power transferred from the engine to the final drive component, e.g. a wheel, of the vehicle, whilst maintaining a high degree of vibration isolation.

In another situation, where the engine 119 is operating at idle and/or the vehicle is operating at steady state, the controller 115 is operable to reduce the stiffness of one or more of the active magnetic bearings 117 in response to a low power output of the powertrain and/or steady state characteristics of the vehicle. Such a reduction in stiffness acts to reduce the transmission of vibration from the powertrain to the vehicle 125, which increases the ride quality and comfort level for an occupant of the vehicle 125. The powertrain mount system 103 according to present disclosure is advantageous as it able to adapt to the real-time operating conditions of the powertrain and/or the vehicle 125 to maximize the performance of the powertrain and/or the vehicle.

Further, by at least partially supporting the powertrain electromagnetically, the present disclosure allows for the removal of physical connections, e.g. rubber mounts, between the powertrain and the body of the vehicle 125, which can decrease the weight and package requirements for the powertrain and/or the vehicle 125.

FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It will be appreciated by those skilled in the art that although the disclosure has been described by way of example with reference to one or more arrangements, it is not limited to the disclosed arrangements and that alternative arrangements could be constructed without departing from the scope of the disclosure as defined by the appended claims.

1. A powertrain mount system for a vehicle powertrain, comprising:
an active magnetic bearing configured to support at least a portion of the powertrain relative to a body portion of the vehicle; and
a controller configured to determine an operational state of at least one of the powertrain and the vehicle and adjust the operation of the active magnetic bearing depending on the operational state of at least one of the powertrain and the vehicle.

2. The powertrain mount system according to claim 1, wherein the controller is configured to adjust a stiffness of the active magnetic bearing in response to dynamic loading of the powertrain.

3. The powertrain mount system according to claim 1, wherein the controller is configured to maintain a stiffness of the active magnetic bearing under steady state loading of the powertrain.

4. The powertrain mount system according to claim 1, wherein the controller is configured to increase a stiffness of the active magnetic bearing in response to an increase in power output of the powertrain.

5. The powertrain mount system according to claim 1, wherein the controller is configured to decrease a stiffness of the active magnetic bearing in response to a decrease in power output of the powertrain.

6. The powertrain mount system according to claim 1, wherein the controller is configured to increase a stiffness of the active magnetic bearing in response to the vehicle performing a maneuver.

7. The powertrain mount system according to claim 1, wherein the controller is configured to adjust a stiffness of the active magnetic bearing in response to an operational frequency of the powertrain.

8. The powertrain mount system according to claim 7, wherein the controller is configured to decrease the stiffness of the active magnetic bearing when the operational frequency of the powertrain is in a range of approximately 10 to 25 Hz.

9. The powertrain mount system according to claim 1, the powertrain mount system further comprising a first bracket attachable to the body portion of the vehicle and a second bracket attachable to the powertrain, wherein the active magnetic bearing is configured to support the first and second brackets relative to each other.

10. The powertrain mount system according to claim 9, wherein the active magnetic bearing is configured to maintain an operational clearance between the first bracket and the second bracket when the active magnetic bearing is energized.

11. The powertrain mount system according to claim 10, the powertrain mount system further comprising a sensor configured to determine the size of the operational clearance.

12. The powertrain mount system according to claim 11, wherein the sensor is provided proximate to an electromagnet of the electromagnetic bearing.

13. A powertrain mount for a vehicle powertrain, the powertrain mount comprising a first bracket and a second bracket, and an electromagnet configured to support the first and second brackets relative to each other.

14. The powertrain mount according to claim 13, the powertrain mount further comprising a sensor configured to measure an operational clearance between the first and second brackets when the electromagnet is energized.

15. The powertrain mount according to claim 14, wherein the sensor is integral with one of the first bracket and the second bracket.

16. The powertrain mount according to claim 14, wherein the sensor is integral with the electromagnet.

17. A method of controlling a powertrain mount system for a vehicle, the system comprising an electromagnetic suspension system comprising an active magnetic bearing configured to support at least a portion of the powertrain relative to the vehicle, and a controller configured to determine an operational state of at least one of the powertrain and the vehicle, the method comprising:
determining the operational state of at least one of the powertrain and the vehicle; and
adjusting an operation of the active magnetic bearing depending on the operational state of at least one of the powertrain and the vehicle.

18. The powertrain mount system according to claim 2, wherein the controller is configured to increase the stiffness of the active magnetic bearing in response to an increase in power output of the powertrain.

19. The powertrain mount system according to claim 2, wherein the controller is configured to decrease the stiffness of the active magnetic bearing in response to a decrease in power output of the powertrain.

20. The powertrain mount system according to claim 2, wherein the controller is configured to increase the stiffness of the active magnetic bearing in response to an increase in power output of the powertrain.
